(19) United States
(12) Patent Application Publication
(10) Pub. No.: US 2009/0119599 A1
(43) Pub. Date: May 7, 2009

(54) Computer, computer-readable medium, and related method for posting a message related to a vehicle license plate

(76) Inventor: John Andrew Hazen, Huntington Beach, CA (US)

Correspondence Address: SHELDON MAK ROSE & ANDERSON PC, 100 Corson Street, Third Floor, PASADENA, CA, 91103-3842, US

(21) Appl. No.: 11/982,664

(22) Filed: Nov. 1, 2007

(51) Int. Cl. G06F 3/048

(52) U.S. Cl. 715/738

(57) ABSTRACT

A computer-readable medium, a computer including the computer-readable medium, and a related method for adding a message regarding a vehicle having a license plate to a web page that is associated with a website. The web page is configured to be displayed on a computer monitor for viewing by a user. The method includes receiving an electronic communication that includes information regarding the license plate and a message that is related to the vehicle, and adding the information regarding the license plate and the message to the web page. The user who views the web page that includes the information regarding the license plate and the message can be anyone who accesses the website.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

A compact disc is included containing computer code listings pursuant to 37 C.F.R. 1.52(e) and is hereby incorporated by reference in its entirety. The compact disc includes the following files (name, size), all of which were copied to compact disc on Oct. 30, 2007: _vti_inf.html, 1,754 bytes; About.aspx, 957 bytes; About.aspx.cs, 403 bytes; about.html, 4,328 bytes; Advertise.aspx, 902 bytes; Advertise.aspx.cs, 407 bytes; advertise.html, 4,332 bytes; arlette.htm, 396 bytes; banner.jpg, 10,339 bytes; banner1.jpg, 10,339 bytes; bg.jpg, 935 bytes; BizPltMail.cs, 23,765 bytes; ChangePassword.aspx, 5,486 bytes; ChangePassword.aspx.cs, 1,416 bytes; check.jpg, 23,986 bytes; ContactInfoVerified, 22 bytes; DBLibrary.d11, 24,576 bytes; DBLibrary.d11.refresh, 34 bytes; DBLibrary.pdb, 24,064 bytes; default.asp, 1,265 bytes; Default.aspx, 6,060 bytes; Default.aspx.cs, 1,690 bytes; Display.ascx, 1,628 bytes; Display.ascx.cs, 1,079 bytes; DisplayForum.aspx, 1,229 bytes; DisplayForum.aspx.cs, 410 bytes; Footer.ascx, 1,062 bytes; Footer.ascx.cs, 411 bytes; Forgotpassword.aspx, 3,588 bytes; Forgotpassword.aspx.cs, 1,013 bytes; form_results.csv, 110 bytes; ftp.xfer_log.20070816, 1,875 bytes; Header.ascx, 5,845 bytes; Header.ascx.cs, 3,517 bytes; Howdoesitwork.aspx, 1,310 bytes; Howdoesitwork.aspx.cs, 411 bytes; howdoesitwork.html, 4,336 bytes; hr.gif, 43 bytes; index.1.jpg, 12,202 bytes; index.2.jpg, 12,047 bytes; index.htm, 342 bytes; index1.old, 6,212 bytes; Interop.ADODB.d11, 102,400 bytes; Interop.CDO.d11, 61,440 bytes; Letthemknow.aspx, 2,013 bytes; Letthemknow.aspx.cs, 409 bytes; letthemknow.html, 4,334 bytes; Links.ascx, 671 bytes; Links.ascx.cs, 652 bytes; ListPlateMail.ascx, 1,689 bytes; ListPlateMail.ascx.cs, 1,927 bytes; Login.aspx, 1,116 bytes; Login.aspx.cs, 403 bytes; Main.aspx, 580 byte; Main.aspx.cs, 405 bytes; MemberLogin.ascx, 3,772 bytes; MemberLogin.ascx.cs, 1,607 bytes; new_page_{—}1.htm, 174 bytes; NewRegistration.ascx, 5,570 bytes; NewRegistration.ascx.cs, 2,504 bytes; NewSiteDefaultPage.asp, 44 bytes; NewsLetter.cs, 5,447 bytes; old_access_log.2007Aug.gz, 31,630 bytes; old_access_log.2007Jul.gz, 33,587 bytes; old_access_log.2007Sep.gz, 10,247 bytes; old_xfer_log.2007Aug.gz, 162 bytes; old_xfer_log.2007Jul.gz, 21,260 bytes; pltmail.css, 2,072 bytes; pltmail.css, 1,782 bytes; Post.aspx, 917 bytes; Post.aspx.cs, 402 bytes; post.gif, 809 bytes; postinfo.html, 2,447 bytes; PostMessage.ascx, 6,236 bytes; PostMessage.ascx.cs, 4,816 bytes; PostMessage.ascx.resx, 7,008 bytes; Privacy.aspx, 7,581 bytes; Privacy.aspx.cs, 405 bytes; privacy.html, 11,339 bytes; RandomString.cs, 9,337 bytes; Registration.aspx, 1,186 bytes; Registration.aspx.cs, 410 bytes; reset.gif, 856 bytes; Search.aspx, 1,172 bytes; Search.aspx.cs, 404 bytes; search.gif, 914 bytes; SearchPlate.ascx, 10,955 bytes; SearchPlate.ascx.cs, 10,006 bytes; SmartNav.htm, 15 bytes; SmartNav.js, 8,728 bytes; SmartNav.js, 8,571 bytes; SmartNavIE5.js, 7,003 bytes; spacer.gif, 43 bytes; Style.css, 60 bytes; Terms.aspx, 933 bytes; Terms.aspx.cs, 403 bytes; terms.html, 4,328 bytes; TestEmail.aspx, 1,093 bytes; TestEmail.aspx.cs, 1,340 bytes; untitled.JPG, 14,654 bytes; untitled.pdf, 82,124 bytes; Web.Config, 2,085 bytes; WebUIValidation.js, 14,606 bytes; WebUIValidation.js, 14,484 bytes; and www.access_log.20070914, 14,545 bytes.

### FIELD OF THE INVENTION

The invention relates generally to the field of computer data and information systems that are accessible via a network. More specifically, the invention relates to a computer-readable medium, a computer that includes the computer-readable medium, and a related method for posting messages on a web page based on the license plate information for an individual's vehicle.

### BACKGROUND

Recently, social networking websites, e.g., myspace.com and facebook.com, have gained in popularity. Also, some websites offer their users ways to post messages, e.g., missed connections on craigslist.com, to people that they have no way of reaching directly. Many times, people want to reach out to and contact people that they have only seen once or a limited number of times. One instance in which this is particularly pertinent is when an individual wants to contact someone who was seen driving a vehicle. It should, therefore, be appreciated that there is a need for a website that facilitates the posting of messages to individuals that were seen driving. The present invention satisfies this need.

### SUMMARY

Embodiments of the present invention include a computer-readable medium, a computer that includes the computer readable medium, and a related method for adding a message regarding a vehicle having a license plate to a web page that is associated with a website. The web page is configured to be displayed on a computer monitor for viewing by a user. An exemplary embodiment of the invention is a computer-readable medium that is included in a first computer. The computer-readable medium contains a program that is configured to interact with information that is stored in a database. The first computer is configured to be coupled to a second computer having a monitor that is configured to display, for viewing by a user, a plurality of web pages that are associated with a website. The program includes additional information that is used to generate the plurality of web pages. One of the plurality of web pages, when displayed on the monitor, is configured to include a message that is associated with a vehicle license plate, and is stored in the database. The one of the plurality of web pages that is configured to include the message that is associated with the vehicle license plate is viewable to anyone who accesses the website.

In other, more detailed features of the invention, when the one of the plurality of web pages is displayed on the monitor, the message has associated with it information regarding the vehicle license plate and a date and a time when the message was added to the one of the plurality of web pages. Also, the license plate information that is associated with the vehicle license plate can be stored in the database, and the license plate information can be a license plate number and a geographic territory that issued the license plate. In addition, another one of the plurality of web pages, when displayed on the monitor, can be configured to facilitate a search that is initiated by the user through the information that is stored in the database for a message that is associated with a specific vehicle license plate.

In other, more detailed features of the invention, the website has associated with it a registered user, and a vehicle license plate is associated with the registered user. The program is configured to prompt the generation and transmission of a notification message to the registered user when a message that is associated with the registered user's vehicle license plate is added to the information that is stored in the database. Also, the notification message can be an electronic-mail message or short message service (“SMS”) message. In addition, the vehicle license plate that is associated with the registered user need not be for a vehicle that is owned or leased by the registered user.

In other, more detailed features of the invention, another one of the plurality of web pages, when displayed on the monitor, is configured to facilitate the entry by the user of the message that is associated with the vehicle license plate and stored in the database. Also, the message that is associated with the vehicle license plate could have been part of an electronic-mail message. In addition, the electronic-mail message could have had an electronic-mail address that included information related to the vehicle license plate. Furthermore, the program could have parsed the license plate information and the message that is to be included in the one of the plurality of web pages from the electronic-mail message. Also, the website can be a social networking website.

Another exemplary embodiment of the invention is a first computer that is configured to be coupled to a second computer via a network. The second computer has a monitor that is configured to display, for viewing by a user, a plurality of web pages that are associated with a website. The first computer includes a computer-readable medium having a program that is configured to interact with information that is stored in a database. The program includes additional information that is used to generate the plurality of web pages. One of the plurality of web pages, when displayed on the monitor, is configured to include a message that is associated with a vehicle license plate and is stored in the database. The one of the plurality of web pages that is configured to include the message that is associated with the vehicle license plate is viewable to anyone who accesses the website. In other, more detailed features of the invention, the network is the Internet, a local-area network, a wide-area network, a regional network, or a wireless network.

An exemplary method according to the invention is a method for adding a message regarding a vehicle having a license plate to a web page that is associated with a website, the web page is configured to be displayed on a computer monitor for viewing by a user. The method includes receiving an electronic communication that includes information regarding the license plate and a message that is related to the vehicle, and adding the information regarding the license plate and the message to the web page. The user who views the web page that includes the information regarding the license plate and the message can be anyone who accesses the website.

In other, more detailed features of the invention, the electronic communication that includes information regarding the license plate and the message that is related to the vehicle is an electronic-mail message or a message that was input using another web page that is associated with the website and was displayed on a computer monitor. Also, if the electronic communication is an electronic-mail message, the electronic-mail message can be sent from another computer, a cellular phone, or a smartphone.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

These and other features, aspects, and advantages of the present invention will become better understood with reference to the following description, appended claims, and accompanying drawings, where:

FIG. 1 is a block diagram of an example system according to a preferred embodiment.

FIG. 2 is a block diagram of an example computer or server according to a preferred embodiment.

FIG. 3 is a diagram of an example home web page according to a preferred embodiment that is provided for viewing by a user.

FIG. 4 is a diagram of an example login web page according to a preferred embodiment that is provided for viewing by a user.

FIG. 5 is a diagram of an example registration web page according to a preferred embodiment that is provided for viewing by a user.

FIG. 6 is a diagram of an example registered user's home web page according to a preferred embodiment that is provided for viewing by a user.

FIG. 7 is a diagram of an example change password web page according to a preferred embodiment that is provided for viewing by a user.

FIG. 8 is a diagram of an example logout web page according to a preferred embodiment that is provided for viewing by a user.

FIG. 9 is a diagram of an example picture web page according to a preferred embodiment that is provided for viewing by a user.

FIG. 10 is a diagram of an example search web page according to a preferred embodiment that is provided for viewing by a user.

FIG. 11 is a diagram of an example message web page according to a preferred embodiment that is provided for viewing by a user.

FIG. 12 is a diagram of another example message web page according to a preferred embodiment that is provided for viewing by a user.

FIG. 13 is a diagram of an example web page according to a preferred embodiment that is provided for viewing by a user and describes how the website works.

FIG. 14 is a diagram of an example web page according to a preferred embodiment that is provided for viewing by a user that includes a downloadable and printable sign that is to be used in combination with the website.

FIG. 15 is a flowchart for an example method for adding a message regarding a vehicle license plate to a web page according to the invention.

FIG. 16 is a schematic illustration of an individual viewing a vehicle license plate.

FIG. 17 is a flowchart for another example method for adding a message regarding a vehicle license plate to a web page according to the invention.

FIG. 18 is a diagram of an example electronic-mail message according to a preferred embodiment.

Unless otherwise indicated, the illustrations in the above figures are not necessarily drawn to scale.

### DETAILED DESCRIPTION

Embodiments of the present invention are directed to a social networking website (the name of the website is PLTMAIL.COM) that allows registered users to create personal profiles online that are associated with one or more vehicle license plate numbers. In particular, drivers of vehicles can create a profile and associate the profile with as many license plate numbers as he or she pleases. Accordingly, the driver can link his or her profile to several different vehicles. The profiles can include visual images, e.g., pictures and videos; audio content, e.g., favorite song(s); social status, e.g., marital status; and a blog for the driver. Accordingly, the profiles are social networking profiles for drivers.

The social networking website allows members of the public to post messages to drivers based on their vehicle's license plate information, i.e., the license plate number and the state that issued the license plate, on a public web page forum that is accessible to anyone via a network, e.g., the Internet. These messages can be viewed by any person who accesses the social networking website. Also, a registered user can be notified automatically after a message is added to the public web page forum that relates to one of the registered user's vehicle license plates.

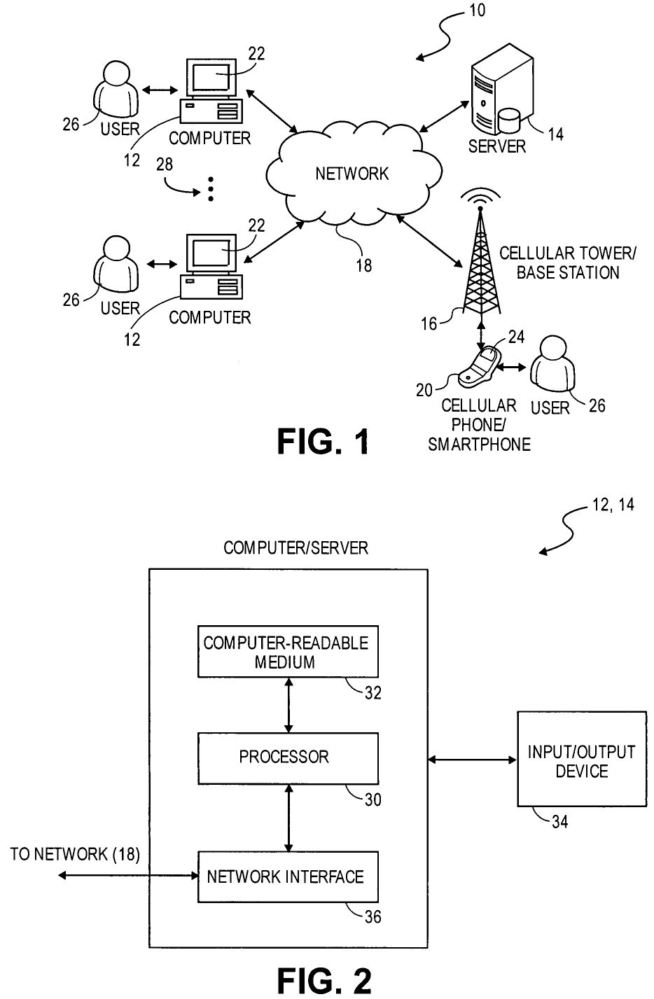

The social networking website can be implemented using the example system 10 illustrated in the block diagram of FIG. 1. The example system includes two user computers 12, a server 14, and a cellular tower/base station 16, all of which are inter-coupled by a network 18, e.g., the Internet. The cellular tower/base station is configured to be coupled to one or more cellular phones 20, which can be smartphones. A smartphone is a cellular phone having computer-like functionality, e.g., Internet access and e-mail access capability. Collectively, the user computers and the cellular phone, and any other device that is operated by a user, e.g., a smartphone, can be referred to as user interface devices, with each user interface device having a graphical user interface (“GUI”) display 22 and 24 that is configured to display images for a user 26.

The term “Internet” generally refers to any collection of networks 18 working together to appear as a single network to a user, and specifically refers to the world-wide network of networks that are interconnected using Internet protocol (“IP”) and other protocols. While the following discussion will focus on the use of the system 10 in the context of the Internet, it is to be understood that the system can be used in other types of computer networks, e.g., local-area networks (“LANs”), wide-area networks (“WANs”), regional networks, and wireless networks. A user 26 of a wireless network can access the Internet and view web pages using a web-enabled cellular phone 20.

Even though only one server 14 is depicted in FIG. 1, it is to be understood that the system 10 can include two or more servers. Also, while only two user computers 12 are depicted in FIG. 1, it should be understood that the system can include only one user computer or more than two user computers as indicated by the series of dots 28 between the two user computers. Furthermore, is should be understood that each of the user computers and the server can include more than one computer or server, respectively. In addition, while only one cellular tower/base station 16 and only one cellular phone or smartphone 20 is depicted in FIG. 1, it should be understood that the system can include two or more cellular tower/base stations or two or more cellular phones or smartphones.

Referring additionally to FIG. 2, each user computer 12 can be a personal computer, workstation, or other computer system, and can include the following: one or more computer processors 30; a computer-readable medium 32; input/output devices 34, e.g. a mouse, a keyboard, and/or a monitor 22 that is configured to display web pages that are viewable by a user 26; and network interfaces 36, e.g., a modem or network interface card, which facilitate communication between each user computer and the network 18. Similarly the server 14, which typically is a computer that is dedicated to a specific task, can include one or more computer processors, computer-readable mediums, input/output devices, and network interfaces, which facilitate communication between each server and the network. In the context of this document, a “computer-readable medium” can be anything that is suitable for long or short-term data storage, e.g., a random access memory (“RAM”), a read-only memory (“ROM”), an erasable programmable read-only memory (“EPROM,” “EEPROM,” or flash memory), a flash memory, a compact disc read-only memory (“CDROM”), a digital video disc (“DVD”), a magnetic cassette, a magnetic tape, a magnetic disk drive, a rewritable optical disk, or any other medium that can be used to store information.

In FIG. 1, the network 18 facilitates communication between the user computers 12, the cellular phone/smartphone 20, and the server 14. All communication on the network can be performed following the Hypertext Transfer Protocol (“HTTP”), or some other network communication protocol that is known in the art, e.g., File Transfer Protocol (“FTP”). For example, the server can be a computer that includes a website's web page information, which is stored in a computer-readable storage medium 32 within the server. The server sends out web page information in response to Hypertext Transfer Protocol (“HTTP”) requests from remote browsers, i.e., the users 26 of the system 10. That is, the server provides the graphical user interface (“GUI”) to the users of the system in the form of web pages. This web page information is sent to the user's device 12 and 20 and result in GUI screens being displayed.

In one example, a user 26 wanting to access one of the website's plurality of web pages would first enter the uniform resource locator (“URL”) for the web page into the browser running on the user's computer 12. Throughout this document, the term “plurality” means two or more. Then, the browser would transfer the user's request, via the network 18, to the server 14 that holds the information for the web page. Next, the information for the requested web page is transferred from the server to the user's computer, and the web page is displayed on the user's computer monitor 22.

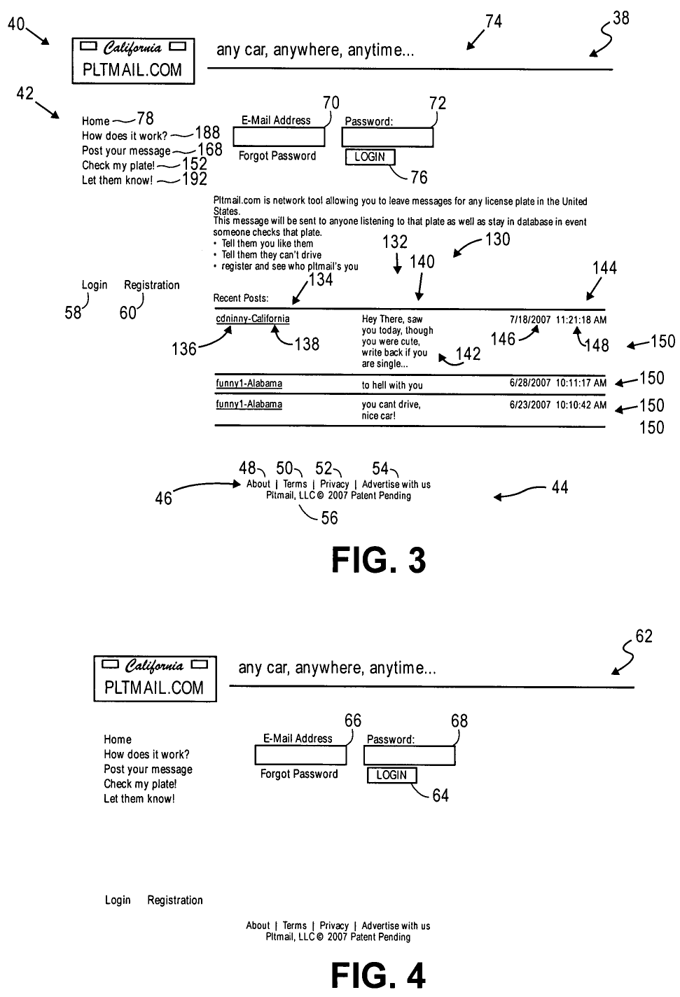

FIG. 3 is an illustration of the website's initial web page 38 (also referred to as the “home web page”) that is displayed on a user's computer monitor 22 as a function of a program that is stored in a computer-readable medium 32 included in the server 14. Even though the website's web pages throughout this document are discussed in the context of being displayed on a user's computer monitor, it should be understood that the website's web pages can be displayed on other devices, for example, the screens 24 of cellular phones or smartphones 20. The program is configured to interact with information that is stored in a database, which is stored in a computer-readable medium that is included in, or coupled to, the server. The program includes information used to generate the website's web pages. The home web page can be viewed by anyone, i.e., a member of the general public, who accesses the website. Accordingly, no membership to the website is required to view the home web page and all of the information that is displayed on the home web page.

A user 26 can enter, select and/or view information on the home web page 38. For example in the left-hand corner 40 of the home web page, the web page includes five links 42 that are selectable by a user. These links, as well as other items are that displayed on the home web page and the other web pages of the website, can be selected using an on-screen pointer in combination with an input/output device 34, e.g., a mouse or the tab key. The links are named the following: “Home,” “How does it work?,” “Post your message,” “Check my plate!,” and “Let them know!”. Selecting one of these five links causes another one of the website's plurality of web pages to be displayed on the user's computer monitor 22, as discussed below. In addition to being displayed on the home web page, these five links are displayed on all of the website's web pages.

The bottom portion 44 of the home web page 38 includes links 46 to various web pages that display information related to the website. For example, the bottom portion of the home web page includes an “About” link 48, a “Terms” link 50, a “Privacy” link 52, and an “Advertise with us” link 54, which when selected prompt the display on the user's computer monitor 22 web pages (not shown) dealing with information regarding the website, the terms of use of the website, the website's privacy statement, and information regarding the process for adding advertisements to the website, respectively. The bottom portion of the home web page also includes copyright notification information 56 for the website. In addition to being displayed on the home web page, the bottom portion of the home web page is included on all of website's web pages.

The home web page 38 also includes two links 58 and 60 that are approximately halfway down the left-hand side of the home web page that are named “Login” and “Registration,” respectively. If the user 26 selects the “Login” link 58, the program prompts the display of the login web page 62 which is shown in FIG. 4. As shown in FIG. 4, the login web page includes a “Login” button 64, an “E-Mail Address” field 66, and a “Password” field 68. A user who is registered with the website, i.e., a registered user, and wishes to login to the website would first type their electronic-mail address in the “E-Mail Address” field, then type their password in the “Password” field, and then select the “Login” button.

Referring back to the home web page 38, an example of which is shown in FIG. 3, a registered user 26 also can login to the website by entering their electronic-mail address and password in the “E-Mail Address” field 70 and the “Password” field 72, respectively, which are located at the top 74 of the home web page, and then select the “Login” button 76. At any point, when the user is viewing a web page other than the home web page, the user can select the “Home” link 78 in the upper left-hand corner 40 of the web page to prompt the display of the home web page.

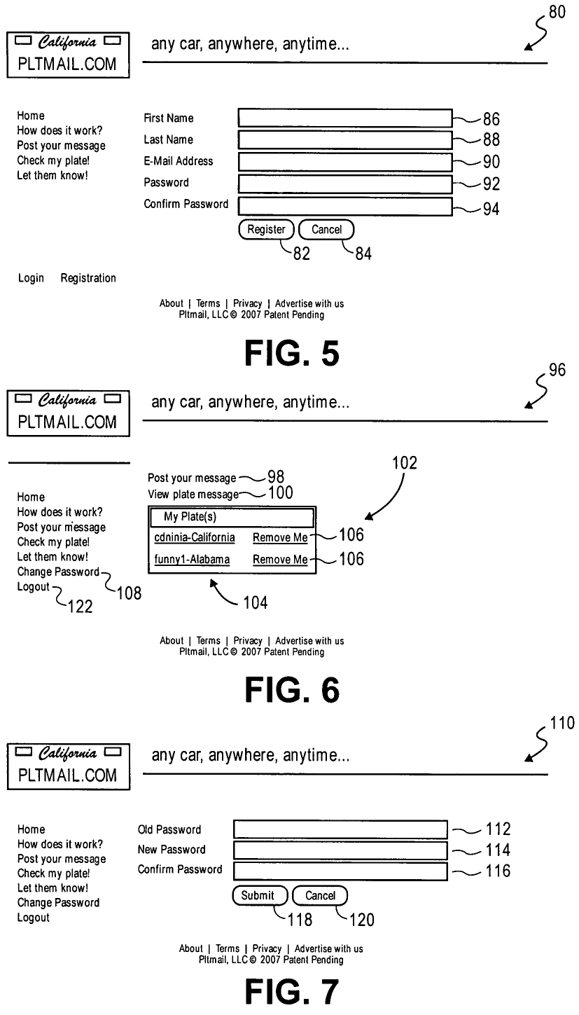

If the website user 26 is not a registered user and wants to become a registered user, the user can select the “Registration” link 60, which is located approximately halfway down the left-hand side of the home web page 38. After selecting the “Registration” link, the program prompts the display of the registration web page 80, an example of which is shown in FIG. 5, on the user's computer monitor 22. The registration web page includes a “Register” button 82, a “Cancel” button 84, and the following five fields: a “First Name” field 86, a “Last Name” field 88, an “E-Mail Address” field 90, a “Password” field 92, and a “Confirm Password” field 94. The user types the appropriate information into each of the five fields, and then selects the “Register” button to become a registered user and to submit the information for storage into the database. At any time, the user can select the “Cancel” button to cancel the registration process and clear the information that the user entered into the registration web page.

After the user 26 completes the registration process, the program prompts the display of a registered user home web page 96, which is shown in FIG. 6. The registered user's home web page includes a “Post your message” link 98, which, when selected by the user, prompts the display of a search web page (discussed below); and a “View plate message” link 100, which, when selected, prompts the display of another search web page (discussed below) that includes a list of messages that are associated with the registered user's license plate. The registered user's home web page also includes a list 102 of license plates 104 that the registered user is monitoring. As shown in FIG. 6, the registered user can select a “Remove Me” link 106 to remove one of the license plates from the list. The vehicle license plate(s) that is associated with the registered user need not be a license plate for a vehicle that is owned or leased by the registered user.

For each of the license plates 104 that are associated with a registered user 26, a notification message can be sent in the form of an electronic-mail message or a short message service (“SMS”) message to the registered user after a message has been posted to the website for their license plate and added to the information that is stored in the database. As indicated in FIG. 6, more than one license plate can be associated with each registered user. The posted messages are never actually sent to the registered users. Rather, the notification message simply tells a registered user that a message has been posted and provides a link back to the search web page, which is described below.

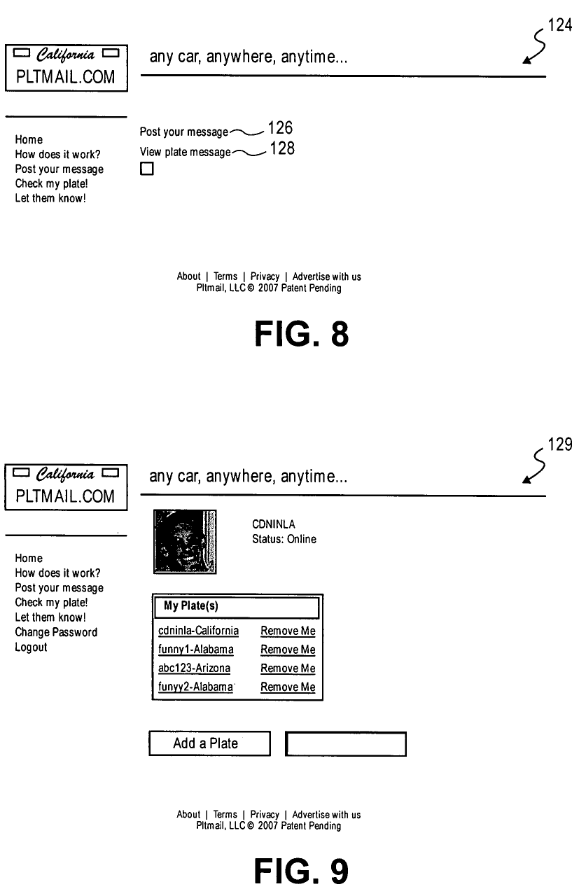

Additionally, the registered user 26, on the registered user's home web page 96, can select the “Change Password” link 108 to cause a change password web page 110, which is shown in FIG. 7, to be displayed where the registered user can input a new password. In particular, the change password web page includes an “Old Password” field 112, a “New Password” field 114, a “Confirm Password” field 116, a “Submit” button 118, and a “Clear” button 120, which in combination can be used by a registered user to update their password. Also, the registered user can select the “Logout” link 122 on the registered user's home page, which prompts the display of a logout web page 124 (shown in FIG. 8) that provides logged out registered users with a “Post your message” link 126 and a “View plate message” link 128. A user that selects the “Post your message” link will prompt the display of a message web page (discussed below), and a user that selects the “View plate message” link from the logout web page will prompt the display of the home web page 38.

Referring additionally to FIG. 9, a picture web page 129, when displayed on the user's computer monitor 22, provides the user 26 with an interface for the entry of the license plate information, the user's status, and pictures (up to a total of N pictures, where N is an integer, which, for example, can equal 100) that will be associated with the user. Any user, even a non-registered user, can see all website profiles, including pictures and related information, that are associated with a license plate. Accordingly, all of the profiles are freely viewable to all users of the website.

Referring again to the home web page 38 shown in FIG. 3, the central portion 130 of the home web page includes a list 132 of recently posted messages. The left-hand portion 134 of the list includes the license plate information, i.e., the license plate number 136, e.g., “funny1” and “cdninla,” followed by a hyphen and the state 138 that issued the license plate, e.g., “California”. The middle portion 140 of the list includes the posted message 142, e.g., “you can't drive, nice car!,” that is associated with the license plate. On the right-hand side 144 of the list is the date 146 and time 148 that the message was added to the website, i.e., posted to the home web page and added to the database. Thus, each row 150 of the list corresponds to one message that is associated with one license plate.

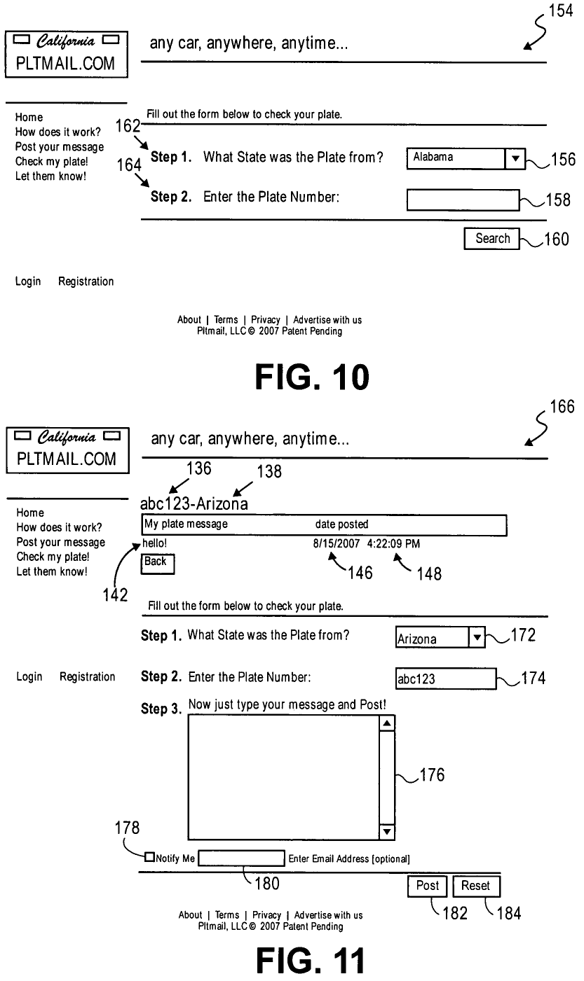

Only the messages 142 that have most recently been posted are shown on the home web page 38. A user 26 that would like to check to see if any messages, even messages that are not currently shown on the home web page, have been posted on the forum for his or her license plate, or any other person's license plate, can select the “Check my plate!” link 152 in the left-hand corner 40 of the home web page, and the program will then prompt the display, on the user's computer monitor 22, of the search web page 154 shown in FIG. 10. The search web page includes a state drop-down window 156, a plate number field 158, and a “Search” button 160.

At “Step 1” 162 on the search web page 154, the user 26 manipulates the state drop-down window 156 to select the state, e.g., “Alabama,” of the user's license plate. While the embodiments of the search web page shown in FIG. 10 request which state the license plate is from in the United States of America, in other embodiments the state can be a state, province, or other geographic territory that is part of a country other than the United States of America, e.g., Canada, Mexico, or another country. In this document, the words “geographic territory” means a geographic area that is under the jurisdiction of a government or country. Next, at “Step 2” 164, the user types the license plate number in the plate number field 158. Finally, the user selects the “Search” button 160, which causes the program to search the information that is stored in the database to see if any messages 142 have been posted on the forum for the specified license plate. If so, an example message web page 166, as shown in FIG. 11, is displayed for the user. The example message web page includes the number 136 and state 138 of the license plate that was searched. The message web page also includes the message(s) 142 that is associated with the license plate, and the date 146 and time 148 the message was posted. If not, then the search web page (FIG. 10) is shown again. Anyone can use the search web page, so a user need not be registered user of the website to search for messages.

As discussed above, a notification message indicates to a registered user 26 that a message 142 has been posted and provides a link back to the search web page 154, which is shown in FIG. 10. After the link to the search web page is selected, the registered user's license plate information including the license plate number 136 and the state of issuance 138 are automatically inserted into the plate number field 158 and the state drop-down window 156, respectively. So, all the registered user needs to do to retrieve his or her messages is to press the search button 160.

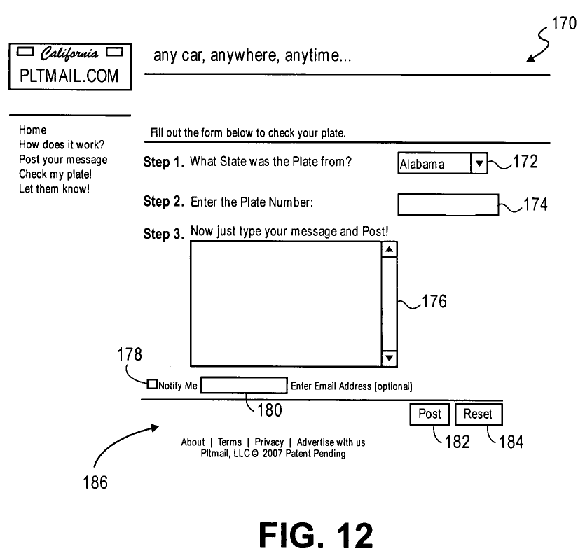

Referring again to the home web page 38 shown in FIG. 3, if the user 26 would like to post a message 142 on the forum, the user would select the “Post your message” link 168 in the upper left-hand corner 40 of the home web page. This would cause the program to prompt the display of the message web page 170 shown in FIG. 12, which includes a state drop-down window 172, a plate number field 174, a message field 176, a “Notify Me” check box 178, an e-mail address field 180, a “Post” button 182, and a “Reset” button 184. A user that wants to post a message would manipulate the state drop-down window to select the state, e.g., “Alabama,” of the license plate with which the message is to be associated. Next, the user would type the license plate number of the license plate with which the message is to be associated in the plate number field. The user then would type the message in the message field.

At the bottom 186 of the message web page 170, the user 26 can select the “Notify Me” check box 178 and type in their electronic-mail address into the e-mail address field 180 if the user wants to be notified via electronic mail when the message 142 is posted on the forum. Next, the user would select the “Post” button 182 to cause the message to be submitted for posting on the home web-page 38, or the user can, at any time, select the “Reset” button 184 to clear the information entered on the message web page. After the “Post” button is selected, the program causes the license plate information and the message to be added to the database and posted on the home web page. Also, the user is presented with a clean version of the message web page that is configured to receive the input of another message. The fields and buttons that are included in the message web page 170 shown in FIG. 12 are also included in the message web page 166 shown in FIG. 11.

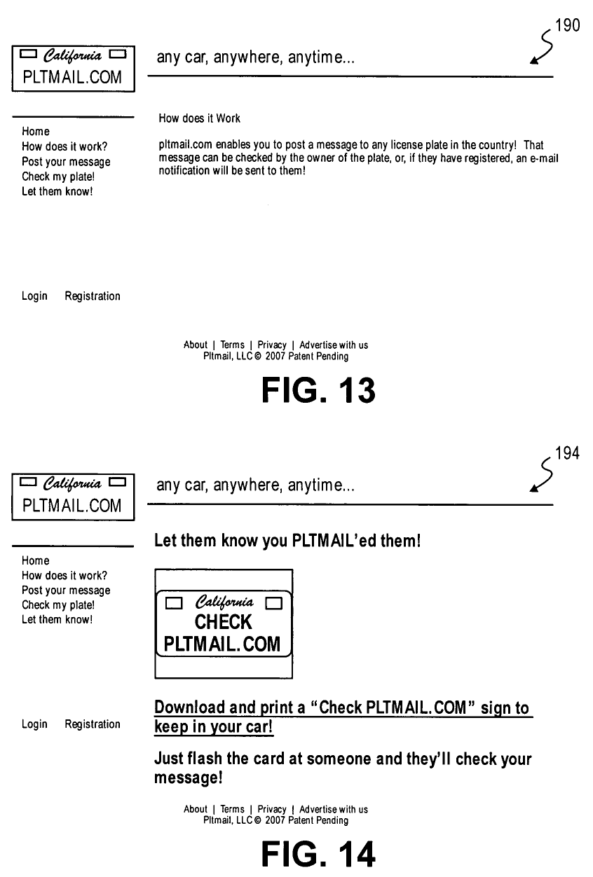

Referring again to the home web page 38 shown in FIG. 3, a user 26 can select the “How does it work?” link 188, which will cause the program to prompt the display of the web page 190 shown in FIG. 13. Likewise, if the user selects the “Let them know!” link 192 on the home web page, the program prompts the display of the Check PLTMAIL.COM sign web page 194, as shown in FIG. 14, which a user can download, printout, and display to someone that they should check the website for a posted message 142.

The information discussed above in relation to the website's web pages 38, 62, 80, 96, 110, 124, 129, 154, 166, 170, 190, and 194 is included in the database, which can be provided in a database system, for example, as a database management system (“DBMS”), and object-oriented database management system (“ODBMS”), a relational database system (e.g., DB2, ACCESS, etc.), a file system or another conventional database package. Thus, the database can be implemented using object-oriented technology or using text files. Further, the database can be accessed via a Structured Query Language (“SQL”) or other tool that is known to individuals having ordinary skill in the art.

The server 14 can access the database that contains information regarding the website's plurality of web pages 38, 62, 80, 96, 110, 124, 129, 154, 166, 170, 190, and 194, including the vehicle license plate information 136 and 138, the messages 142, and the registered users 26. The database information can be configured in tables, for example the five tables that are discussed below. While only five tables are discussed below, it should be understood that the database can include other tables, for example, profile tables, which include data related to the profiles that can be associated with registered users.

A user 26 who registers with the website enters their user information into the database into the “User Table,” an example of which is shown below. The “User Table” includes the user's identification number (“UserID”), which is an alphanumeric identifier that is associated with the registered user. The “User Table” also includes the user's password (“Pwd”), the user's electronic-mail address (“Email”), the user's first and last names (“First Name” and “Last Name,” respectively) (all of which are in alphanumeric format). In other embodiments, the “User Table” also includes the registered user's status, for example, the registered user's marital status, interests, and/or hometown.

### User Table

| | | | First | Last |
|---|---|---|---|---|
| UserID | Pwd | Email | Name | Name |
| 1 | abcde | johndoe@aol.com | John | Doe |
| 2 | 123456 | janedoe@verizon.net | Jane | Smith |

The “Notify Table” is another example table that can be included in the website's database. An example of the “Notify Table” is shown below. The “Notify Table” includes the registered user's MemberID, the registered user's PlateID number(s), and the registered user's UserID (all of which are of an alphanumeric format). Accordingly, the “Notify Table” associates the User ID with the license PlateID numbers The “Notify Table” also includes a “Notify” indicator (alphanumeric format), which indicates whether the registered user 26 wants to be notified when a message 142 is posted for the associated license plate number (“TRUE” indicates that the registered user wants to be notified when a message is posted, and “FALSE” indicates that the registered user does not want to be notified when a message is posted).

### Notify Table

| MemberID | PlateID | UserID | Notify |
|---|---|---|---|
| 1 | 1 | 2 | FALSE |
| 4 | 1 | 5 | TRUE |

The “Plate Table” is another example table that can be stored in the website's database and includes the license plate number 136 and the state 138 that issued the license plate for each vehicle license plate that is stored in the database. An example of the “Plate Table” is shown below and includes the following: a PlateID, which can be an alphanumeric string having a length of up to 18 characters; the UserID; the Plate Number; the State from which the plate is issued; and the Date Created, which is an alphanumeric identifier for the date 146 the record was added to the table. Accordingly, the “Plate Table” associates the registered user's UserID with the PlateID, the plate number, and the state where the plate is issued.

### Plate Table

| PlateID | UserID | Plate Number | State | Date Created |
|---|---|---|---|---|
| 1 | 1 | cdninla | CA | 3/1/2007 |
| 2 | 1 | funny1 | AL | 5/5/2007 |

The “State Table” is yet another example table that can be stored in the website's database and includes an alphanumeric identifier (“StateID”), which can be a string having a length of up to 18 characters, for the state; the full name of the state (“State”); and an abbreviation (“Abbreviation”), e.g., NY or CA, for the name of the state.

### State Table

| StateID | State | Abbreviation |
|---|---|---|
| 1 | California | CA |
| 2 | New York | NY |

The “Plate Mail Table” is another example table that can be stored in the website's database and includes the following: an electronic-mail identifier (“MailID”), which can be an alphanumeric string having a length of up to 18 characters; the UserID; the text of the message (“Message”) 142, e.g., “you can't drive, nice car!”; the PlateID; and the date 146 and time 148 the message was posted (“Date/Time Posted”).

### Plate Mail Table

| MailID | UserID | Message | PlateID | Date/Time Posted |
|---|---|---|---|---|
| 1 | 20 | to hell with you | 5 | 7/18/2007 11:21:18 AM |
| 2 | 42 | you can't drive, | 12 | 6/28/2007 10:11:17 AM |
| | | nice car! | | |

The “Picture Table” is another example table that can be stored in the website's database and includes the following: the UserID; the PictureID, which can be an alphanumeric string that is unique to each picture; a Picture Order number, which can be an alphanumeric string that identifies the order of the photos if more than one photo is associated with a single UserID; and a Picture File, which can be an alphanumeric string that that identifies a binary large object (“BLOB”) (as shown below). Thus, the Picture Table includes reference identifiers for pictures that are associated with the user 26, e.g., Picture 1 through Picture N, are included, where N is an integer that can be for example 100. Accordingly, in the example case where N is 100, the user can associate up to 100 different pictures with the user's profile. Each picture can be identified by a number that is associated with the user's electronic-mail address. Accordingly, the user, when he or she registers with the website and inputs data that is to be included in the database, can associate visual images, e.g., pictures, with his or her electronic-mail address, which can be viewed by the public. A user of the website will use the web pages to search for a license plate and will be able to see information that is related to the registered user(s) that is linked to the license plate and will be able to click on the registered user's profile and see the pictures.

### Picture Table

| UserID | PictureID | Picture Order | Picture File |
|---|---|---|---|
| 1 | 1 | 1 | sdjskdslkjflkslkfdjldfkgd |
| 1 | 4 | 2 | tjzxgxnnnbn |

Information is shared between the five tables shown above. For example, the UserID is included in the “User Table,” the “Notify Table,” the “Plate Table,” the “Plate Mail Table,” and the “Picture Table”. Also, the PlateID is included in the “Notify Table,” the “Plate Table,” and the “Plate Mail Table”. In addition, the state information is included in both the “Plate Table” and the “State Table”.

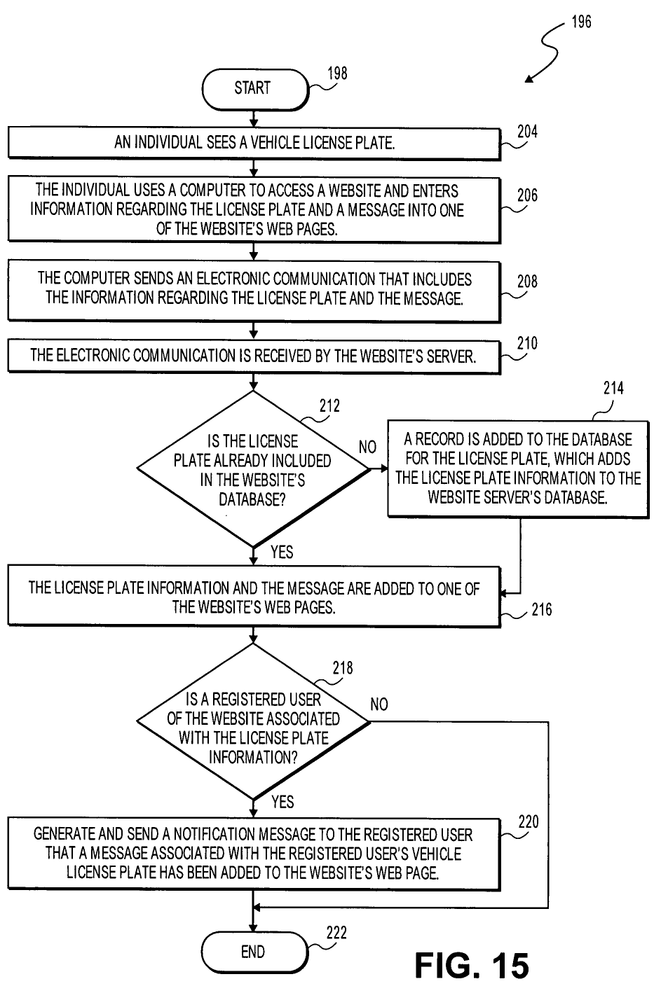

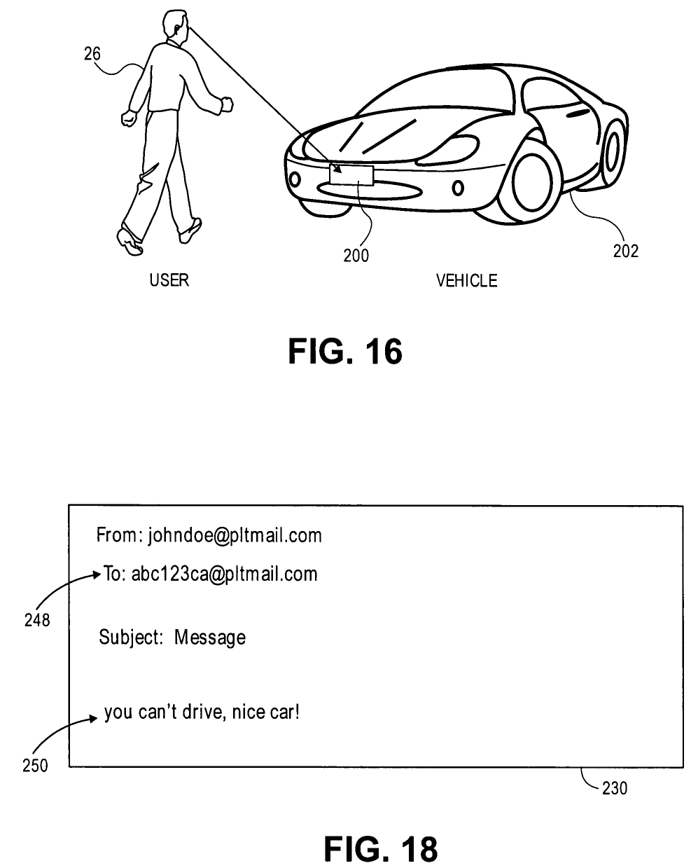

Referring additionally to the method illustrated in the flowchart 196 shown in FIG. 15, which starts at step 198, use of the website typically is predicated on a user 26 viewing the license plate 200 of a vehicle 202 that is associated with an individual of interest (see step 204 and FIG. 16). After viewing the vehicle license plate, the user uses his or her computer 12 to access the website, and, in particular, uses the website's message web page 170 to enter information regarding the vehicle license plate and a message 142 (see step 206). Next, at step 208, the computer sends an electronic communication that includes the information regarding the license plate and the message.

At step 210, the electronic communication is received by the website's server 14. Next, at step 212, the program that is running on the server determines if information that is associated with the license plate 200 is already included in the website's database. If not, at step 214, a record is added to the website's database for the license plate, which adds the license plate information to the website server's database. Next, at step 216, the license plate information and the message 142 are added to one of the website's web pages, e.g., the home web page 38.

At step 218, the program determines if a registered user 26 of the website is associated with the license plate information. If so, at step 220, the program prompt the generation and the sending, e.g., transmission, of a notification message, e.g. an electronic-mail message, to the registered user that a message 142 that is associated with the, or one of the, registered user's license plate(s) 200 has been added to one of the website's web pages 38. The method-ends at step 222.

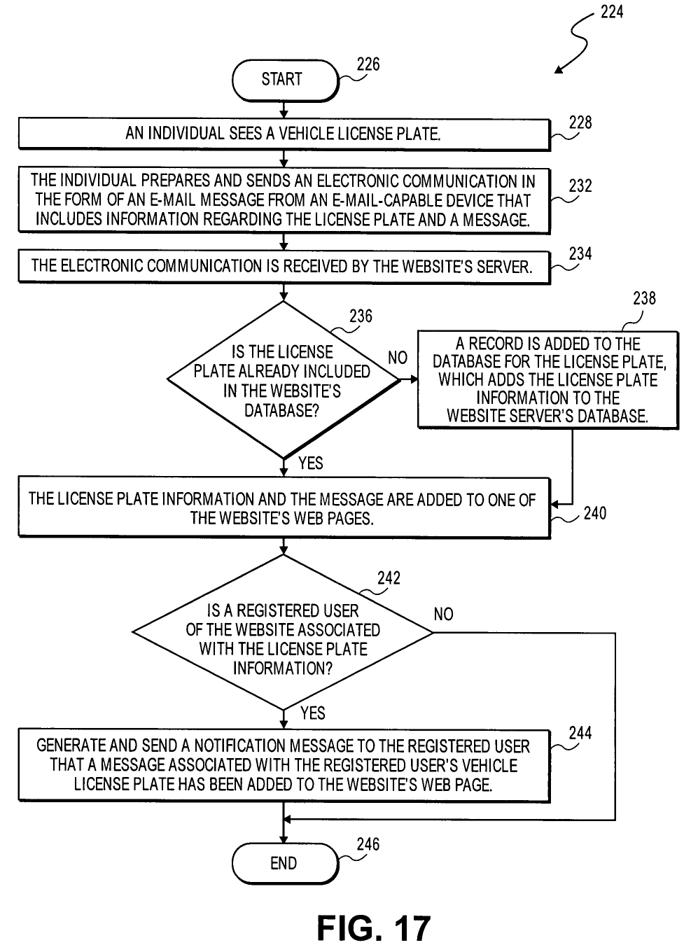

Referring additionally to another method illustrated in the flowchart 224 shown in FIG. 17, which starts at step 226, use of the website again is predicated on a user 26 viewing the license plate 200 of a vehicle 202 that is associated with an individual of interest (see step 228 and FIG. 16). After viewing the vehicle license plate, the user prepares and sends an electronic communication in the form of an electronic-mail message 230 (see FIG. 18) from an electronic-mail-capable device, e.g., a computer 12, a cellular phone or a smartphone 20, etc., that includes information regarding the vehicle license plate and a message 142 (see step 232).

At step 234, the electronic communication is received by the website's server 14. Next, at step 236, the program that is running on the server determines if information that is associated with the license plate 200 is already included in the website's database. If not, at step 238, a record is added to the website's database for the license plate, which adds the license plate information to the website server's database. Next, at step 240, the license plate information and the message 142 are added to one of the website's web pages, e.g., the home web page 38.

At step 242, the program determines if a registered user 26 of the website is associated with the license plate information. If so, at step 244, the program prompt the generation and the sending, e.g., transmission, of a notification message, e.g. an electronic-mail message or a short message service (“SMS”) message, to the registered user that a message 142 that is associated with the, or one of the, registered user's license plate(s) 200 has been added to one of the website's web pages 38. The method ends at step 246.

Referring additionally to FIG. 18, in the above example, the user 26 could send an electronic-mail message 230 where the e-mail address 248 for the recipient includes the license plate information, e.g., the recipient's e-mail address for the message is abc123ca@pltmail.com, where the license plate number 136 is abc123 and the plate's state 138 is California. The website's server 14, upon receipt of the electronic-mail message, then forwards the electronic-mail message to the program, which parses out the license plate number and the state that issued the license plate from the electronic-mail message's address.

The program according to embodiments of the present invention are stored in a computer-readable medium 32, which can be included in a computer 12, e.g., a server 14. The program can be stored in the computer-readable medium as executable instructions, source or object code, or another format that is configured to be executed by the computer's processor 30. Excerpts of code for one embodiment of the program are stored in the compact disc that is noted in the beginning portion of this document, and is incorporated by reference in its entirety herein.

Advantageously, the website according to the present invention allows users 26 to post messages 142 to individuals that were seen in a specific vehicle 202 based on the vehicle's license plate information. Thus, the present invention provides individuals with a forum for posting messages to people who they might not otherwise reach. The website is a public forum that allows many people to view and monitor messages that are associated with many different vehicle license plates. The forum is an open space viewable to any users, and thus, the messages are not proprietary. There is no requirement for a user to register with the website to view the messages posted on the website's web pages 38.

The license plate information 136 and 138, messages 142, and message-related information, e.g., the date 146 and the time 148 that the message was posted, are included in the database, and they can be queried or read by anyone 26 who knows a license plate number. A registered user can monitor as many different license plate numbers as he pleases, even for license plates 200 that are not associated with vehicles 202 owned or leased by the registered user. Also, a registered user is notified when a message regarding one of the registered user's license plates has been added to the website.

Another advantage of the present invention is that the website allows messages 142 that are sent via electronic-mail messages 230 to be posted automatically on the website's web pages 38. The website's program does this by parsing the address 248 of the electronic-mail message to determine the state 138 and number 136 of the license plate 200. The program then takes the body 250 of the electronic-mail message and inputs that as the message that is to be displayed on the website's home web page 38. The electronic-mail message can be sent from a computer 12, or a cellular phone or a smartphone 20. These methods of automatically posting a message on the website's web pages provide fast results.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

I claim:

1. A computer-readable medium that is included in a first computer, wherein the computer-readable medium contains a program that is configured to interact with information that is stored in a database, and the first computer is configured to be coupled to a second computer having a monitor that is configured to display, for viewing by a user, a plurality of web pages that are associated with a website, the program comprising additional information used to generate the plurality of web pages, wherein:
a. one of the plurality of web pages, when displayed on the monitor, is configured to include a message that:
i. is associated with a vehicle license plate, and
ii. is stored in the database; and
b. the one of the plurality of web pages that is configured to include the message that is associated with the vehicle license plate is viewable to anyone who accesses the website.

2. The computer-readable medium according to claim 1, wherein when the one of the plurality of web pages is displayed on the monitor, the message has associated with it information regarding the vehicle license plate and a date and a time when the message was added to the one of the plurality of web pages.

3. The computer-readable medium according to claim 1, wherein:
a. license plate information that is associated with the vehicle license plate is stored in the database; and
b. the license plate information is selected from the group consisting of a license plate number and a geographic territory that issued the license plate.

4. The computer-readable medium according to claim 1, wherein another one of the plurality of web pages, when displayed on the monitor, is configured to facilitate a search that is initiated by the user through the information that is stored in the database for a message that is associated with a specific vehicle license plate.

5. The computer-readable medium according to claim 1, wherein:
a. the website has associated with it a registered user;
b. a vehicle license plate is associated with the registered user; and
c. the program is configured to prompt the generation and transmission of a notification message to the registered user when a message that is associated with the registered user's vehicle license plate is added to the information that is stored in the database.

6. The computer-readable medium according to claim 5, wherein the notification message is selected from the group consisting of an electronic-mail message and a short message service message.

7. The computer-readable medium according to claim 5, wherein the vehicle license plate that is associated with the registered user need not be for a vehicle that is owned or leased by the registered user.

8. The computer-readable medium according to claim 1, wherein another one of the plurality of web pages, when displayed on the monitor, is configured to facilitate the entry by the user of the message that is associated with the vehicle license plate and stored in the database.

9. The computer-readable medium according to claim 1, wherein the message that is associated with the vehicle license plate was part of an electronic-mail message.

10. The computer-readable medium according to claim 9, wherein the electronic-mail message had an electronic-mail address that included information related to the vehicle license plate.

11. The computer-readable medium according to claim 10, wherein the program parsed the license plate information and the message that is to be included in the one of the plurality of web pages from the electronic-mail message.

12. The computer-readable medium according to claim 1, wherein the website is a social networking website.

13. A first computer that is configured to be coupled to a second computer via a network, wherein the second computer has a monitor that is configured to display for viewing by a user a plurality of web pages that are associated with a website, the first computer comprising:
a. a computer-readable medium having a program that:
i. is configured to interact with information that is stored in a database, and
ii. includes additional information that is used to generate the plurality of web pages;
b. wherein:
i. one of the plurality of web pages, when displayed on the monitor, is configured to include a message that is associated with a vehicle license plate and is stored in the database, and
ii. the one of the plurality of web pages that is configured to include the message that is associated with the vehicle license plate is viewable to anyone who accesses the website.

14. The first computer according to claim 13, wherein another one of the plurality of web pages, when displayed on the monitor, is configured to facilitate a search that is initiated by the user through the information that is stored in the database for a message that is associated with a specific vehicle license plate.

15. The first computer according to claim 13, wherein another one of the plurality of web pages, when displayed on the monitor, is configured to facilitate the entry by the user of the message that is associated with the vehicle license plate and stored in the database.

16. The first computer according to claim 13, wherein:
a. the website has associated with it a registered user;
b. a vehicle license plate is associated with the registered user; and
c. the program is configured to prompt the generation and sending of a notification message to the registered user of the website when a message that is associated with the registered user's vehicle license plate is added to the information that is stored in the database.

17. The first computer according to claim 13, wherein:
a. the message that is associated with the vehicle license plate was input to the first computer via an electronic-mail message;
b. the electronic-mail message had an electronic-mail address that included information related to the vehicle license plate; and
c. the program parsed the vehicle license plate information and the message that is to be included in the one of the plurality of web pages from the electronic-mail message.

18. The first computer according to claim 13, wherein the network is selected from the group consisting of the Internet, a local-area network, a wide-area network, a regional network, and a wireless network.

19. A method for adding a message regarding a vehicle having a license plate to a web page that is associated with a website, the web page is configured to be displayed on a computer monitor for viewing by a user, the method comprising:
a. receiving an electronic communication that includes information regarding the license plate and a message that is related to the vehicle; and
b. adding the information regarding the license plate and the message to the web page;
c. wherein the user who views the web page that includes the information regarding the license plate and the message can be anyone who accesses the website.

20. The method according to claim 19, wherein:
a. the website has associated with it a registered user;
b. a vehicle license plate is associated with the registered user; and
c. the method further comprises generating and transmitting a notification message to the registered user when a message that is associated with the registered user's vehicle license plate is added to the web page.

21. The method according to claim 20, wherein the notification message is selected from the group consisting of an electronic-mail message and a short message service message.

22. The method according to claim 19, wherein the electronic communication that includes information regarding the license plate and the message that is related to the vehicle is selected from the group consisting of an electronic-mail message and a message that was input using another web page that is associated with the website and was displayed on a computer monitor.

23. The method according to claim 19, wherein:
a. the electronic communication is an electronic-mail message; and
b. the electronic-mail message was sent from an electronic device selected from the group consisting of another computer, a cellular phone, and a smartphone.
